(19) United States
(12) Patent Application Publication
(10) Pub. No.: US 2017/0276767 A1
(43) Pub. Date: Sep. 28, 2017

(54) Visible Light Based Indoor Positioning System

(71) Applicant: University of South Australia, Adelaide (AU)

(72) Inventors: Siu Wai Ho, Adelaide (AU); Yasir Muhammad, Adelaide (AU); Badri Narayanan Vellambi Ravisankar, Adelaide (AU)

(21) Appl. No.: 15/535,096

(22) PCT Filed: Dec. 10, 2015
(86) PCT No.: PCT/AU2015/000745

§ 371 Date: Jun. 14, 2017

(30) Foreign Application Priority Data
Dec. 10, 2014 (AU) 2014905003

(51) Int. Cl. G01S 5/16; H04B 10/66; H04B 10/50; G01S 1/70; H04B 10/116

(52) U.S. Cl. CPC G01S 5/163; G01S 1/70; H04B 10/116; H04B 10/502; H04B 10/66

(57) ABSTRACT

A method for enabling indoor positioning of a mobile receiver, including: detecting an orientation of the mobile receiver; measuring light intensities using at least three effective visible light receiving areas positioned on the mobile receiver, wherein the at least three effective visible light receiving areas are orientated such that a measurement of light intensity of a light from the same light source by each of the at least three effective visible light receiving areas is different from the others; and producing an output which enables a 3-dimensional indoor positioning of the mobile receiver relative to a second coordinate system.

### PRIORITY DOCUMENT

The present application claims priority from Australian Provisional Patent Application No. 2014905003 titled “Visible Light Based Indoor Positioning System” and filed on 10 Dec. 2014, the content of which is hereby incorporated by reference in its entirety.

### TECHNICAL FIELD

The present invention relates to an indoor positioning system based on visible light.

### BACKGROUND

Location-based services are becoming increasingly important. By knowing a user's physical location, a mobile device can provide adequate information to the user and support different mobile applications. For example, a person can have navigation applications and tracking/monitoring applications in his/her smartphone. In communications networks, applications such as network planning, network adaptation, load balancing, etc. can be done if the location information of the users is known. Different techniques have been developed for both outdoor and indoor positioning.

For outdoor scenarios, a well-established navigation system is called Global Positioning System (GPS). GPS is being widely used, not to only locate users' positions, but also to track paths of mobile user. GPS is a satellite-based system, which relies on signals from at least four satellites to estimate user coordinates. The positioning accuracy of GPS is in the order of several meters, which is not acceptable in indoor scenarios. Moreover, satellite signals also suffer serious attenuation inside buildings, causing that GPS cannot be used as an acceptable indoor navigation system.

For indoor scenarios, different systems have been proposed, including radio frequency (RF) based systems, infrared based systems and ultrasonic based systems. There are many pros and cons of these proposed systems. Some of them use existing infrastructure, hence are not costly, but their positioning accuracy is up to five meters. Some systems have good positioning accuracy like ultra wideband (UWB) systems; however, they are costly. Similarly, some positioning systems, such as cellular-based positioning systems estimate user's position from the base station (BS), raise privacy concerns to users.

Visible light communications (VLC) is getting attention due to advances in light emitting diodes (LEDs) and photosensors. The visible light spectrum is license-free and has much wider bandwidth compared with the radio frequency (RF). VLC is energy efficient as visible light can be used for both illumination and communication purposes, besides being used for indoor positioning. Moreover, one can use VLC in RF-sensitive areas like hospitals.

Note that, in this specification, the term “positioning” and “tracking” can be used interchangeably to mean obtaining or calculating a location and/or an orientation of a mobile device. The so called obtaining or calculating can be performed by the mobile device or by a device external to the mobile device. The motion device can be in motion or static when the “positioning/tracking” is performed. Note that any physical add-on to the mobile device can be considered part of the mobile device.

### SUMMARY

According to a first aspect to the invention, there is provided a method for enabling indoor positioning of a mobile receiver, including: detecting an orientation of the mobile receiver relative to a first coordinate system; measuring light intensities using at least three effective visible light receiving areas positioned on the mobile receiver, wherein the at least three effective visible light receiving areas are orientated such that a measurement of light intensity of a light from the same light source by each of the at least three effective visible light receiving areas is different from the others; and producing an output which enables a 3-dimensional indoor positioning of the mobile receiver relative to a second coordinate system, based on (1) signals representing light intensities of lights from at least two different light sources positioned relative to the second coordinate system, measured by the at least three effective visible light receiving areas, (2) positions of the at least two different light sources relative to the second coordinate system, and (3) the detected orientation of the mobile receiver relative to the first coordinate system.

According to a second aspect to the invention, there is provided an indoor positioning system, including: at least two different light sources positioned relative to a second coordinate system for providing visible light signals to a single optical receiver; and a mobile receiver, including: a device for detecting an orientation of the mobile receiver relative to a first coordinate system; at least three effective visible light receiving areas for measuring light intensities, wherein the at least three effective visible light receiving areas are orientated such that a measurement of light intensity of a light from the same light source by each of the at least three effective visible light receiving areas is different from the others; and a processor programmed to produce an output which enables a 3-dimensional indoor positioning of the mobile receiver relative to a second coordinate system, based on process (1) signals representing light intensities of lights from the at least two different light sources, measured by the at least three effective visible light receiving areas, (2) positions of the at least two different light sources relative to the second coordinate system, and (3) the detected orientation of the mobile receiver, to produce an output which enables a 3-dimensional indoor positioning of the mobile receiver relative to the second coordinate system.

According to a third aspect to the invention, there is provided a mobile receiver, including: a device for detecting an orientation of the mobile receiver relative to a first coordinate system; at least three effective visible light receiving areas for measuring light intensities, wherein the at least three effective visible light receiving areas are orientated such that a measurement of light intensity of a light from the same light source by each of the at least three effective visible light receiving areas is different from the others; and a processor programmed to produce an output which enables a 3-dimensional indoor positioning of the mobile receiver relative to a second coordinate system, based on process (1) signals representing light intensities of lights from the at least two different light sources measured by the at least three effective visible light receiving areas, (2) positions of the at least two different light sources relative to the second coordinate system, and (3) the detected orientation of the mobile receiver, to produce an output which enables a 3-dimensional indoor positioning of the mobile receiver relative to the second coordinate system.

### BRIEF DESCRIPTION OF DRAWINGS

Embodiments of the present invention will be discussed with reference to the accompanying drawings wherein:

FIG. 1 depicts steps according to one aspect of the present invention to enable indoor positioning based on visible light;

FIG. 2 depicts an indoor positioning system according to one embodiment of the present invention;

FIG. 3 depicts a simple model of angles between a LED and a Photodiode (PD);

FIG. 4 depicts a spherical coordinate system;

FIG. 5 depicts a model in which the separation of PDs are zero;

FIG. 6 depicts the differences between the coordinate system of the receiver and the coordinate system of a room;

FIG. 7 depicts a model in which the separation of PDs are non-zero;

FIG. 8a depicts Algorithm 1 which gives an estimate of the user's position by assuming that all the photodiodes are placed at the same location; FIG. 8b depicts an alternative of Algorithm 1;

FIG. 9 depicts a model of a transmitter and a receiver for power correction;

FIG. 10a depicts Algorithm 2 which gives an estimate of the user's position without a need to assume that all the photodiodes are placed at the same location; FIG. 10b depicts an alternative of Algorithm 2;

FIG. 11 and FIG. 12 show an example of the circuits of the receiver and the transmitter respectively;

FIG. 13 depicts a Time Division Multiple Access (TDMA) scheme;

FIG. 14 illustrates a typical output of the four photodiodes in TDMA scenario;

FIG. 15 presents the simulation results for position errors for different values of the luminous flux emitted by the LEDs;

FIG. 16 presents the simulation results for position errors for different values of the luminous flux emitted by the LEDs;

FIG. 17 compares a published system with the present invention;

FIG. 18 presents the error between X-coordinate and estimated X-coordinate of the receiver for different speeds;

FIGS. 19 and 20 present the error between actual Y-coordinate and Z-coordinate and estimated Y-coordinate and Z-coordinate of the receiver;

FIG. 21 shows the differences between the actual and estimated path when the receiver was moving with the speed of 1.3 m/s; and

### DESCRIPTION OF EMBODIMENTS

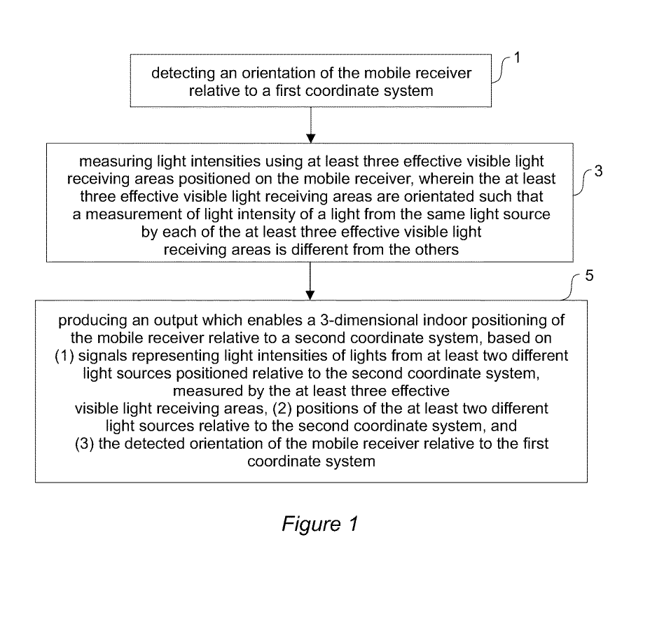

FIG. 1 depicts steps according to one aspect of the present invention to enable indoor positioning based on visible light. In particular, these steps involve firstly step 1 of detecting an orientation of the mobile device relative to a first coordinate system. This can be performed using one or more accelerometers. The mobile device can be any electronic device carried by a person, such as a mobile phone, a PDA, a NFC device, laptop, etc. It can also be an electronic device positioned or installed on a trolley, stroller etc., as long as the mobile device can be used indoor. A coordinate system can be of any form known to a skilled addressee, as long as it provides a reference system to track the orientation of the mobile device. In one form, the coordinate system is one of Earth-centered Cartesian coordinate system and Earth-centered spherical/ellipsoidal coordinate system. Other means may be used to replace the accelerometer as long as they are able to at least detect the direction of the gravitational force relative to the mobile device.

Besides detecting the direction of the gravitational force (sometimes known as the Z-direction), the accelerometer may be used, but not necessarily, to detect movement in the X and Y direction of the mobile to enhance tracking of the mobile device in an indoor environment.

The next step 3 involves measuring light intensities using at least three effective visible light receiving areas positioned on the mobile receiver, wherein the at least three effective visible light receiving areas are orientated such that a measurement of light intensity of a light from the same light source by each of the at least three effective visible light receiving areas is different from the others. Effective visible light receiving areas can be provided by one or more optical receivers, also known as visible light detectors. Visible light is defined typically to include wavelengths from about 390 to 700 nm which corresponds to frequencies within the vicinity of 430-790 THz. The receivers can be in any form. The only requirement is that they are orientated in a way such the intensity of a single light source measured by them would be different. In one form, the receivers are tilted in different angles with respect to an arbitrary axis. The receivers may be of different designs and model provided the measured light intensities are different from the same light source. Note that the measurement of light intensity is to include measurement of radiance, measurement of luminous intensity and any other methods which measure and quantify intensity/strength of lights.

In a broad form, only three effective visible light receiving areas are needed. The three effective visible light receiving areas can be contained within a single protecting casing, as long as the areas are orientated such that that a measurement of light intensity of a light from the same light source by each of the areas is different from the others.

The next step 5 involves signal processing. In particular, it involves processing two set of signals or data. The first set includes signals representing light intensities of lights from at least two different light sources positioned relative to a second coordinate system, measured by the at least three effective visible light receiving areas. As mentioned in step 3, the three effective visible light receiving areas are setup such that light intensity of a light from the same light source would generate different measurements on the three effective visible light receiving areas. For the invention to work, there should be two different light sources. Since it is visible light, the two different light sources are within a line of sight of the effective visible light receiving areas in a simplest form. However, it is possible to have reflectors, optical fibre etc. acting as a “secondary” light source directing light from a “primary” light source not within the line of sight of the effective visible light receiving areas, to the effective visible light receiving areas. The second set of signals or data includes the detected orientation of the mobile device. This set of data of signals is provided by the accelerometer mentioned in step 1. The processing of step 5 then produces an output which enables a 3-dimensional indoor positioning of the mobile receiver relative to the second coordinate system. The 3-dimensional indoor positioning of the mobile receiver includes providing coordinates and an orientation of the mobile receiver relative to the second coordinate system. In the processing of step 5, the locations of the at least two different light sources relative to the second coordinate system is required. The location information can be transmitted to the mobile device through various means, for example, though a WIFI connection with an access point or though the signals from the light sources. The location information can also be pre-downloaded. Note that it is only required for the mobile device to receive the location information once, but the location information can be constantly updated if required.

Note that the two different light sources may be using different lights. For example, it can be light of different colour/wavelength. The two different light sources may emit different light intensities. The light sources may be LEDs, DC incandescence light bulb etc. In one form, the light source is capable of producing light of substantially constant intensity. A light is considered as light of substantially constant intensity when the intensity variation is within 5% of error during the working of the light (excluding transient intensity, for example, when turning on the light). Light sources running on AC may not be suitable as there will be fluctuation in AC power supply. Nonetheless, if the supplied AC is of substantially fixed RMS value and substantially fixed frequency, then light sources running on AC may be suitable for the purpose of this invention. For example, it is still possible to have the light sources emit a triangular wave or even a sine wave. Another possibility is to use an AC to DC converter when having an AC power supply.

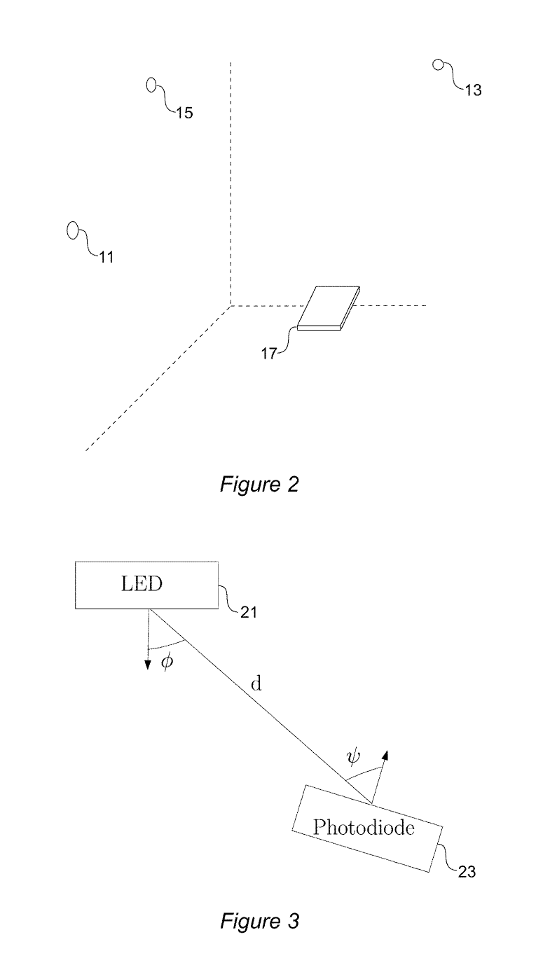

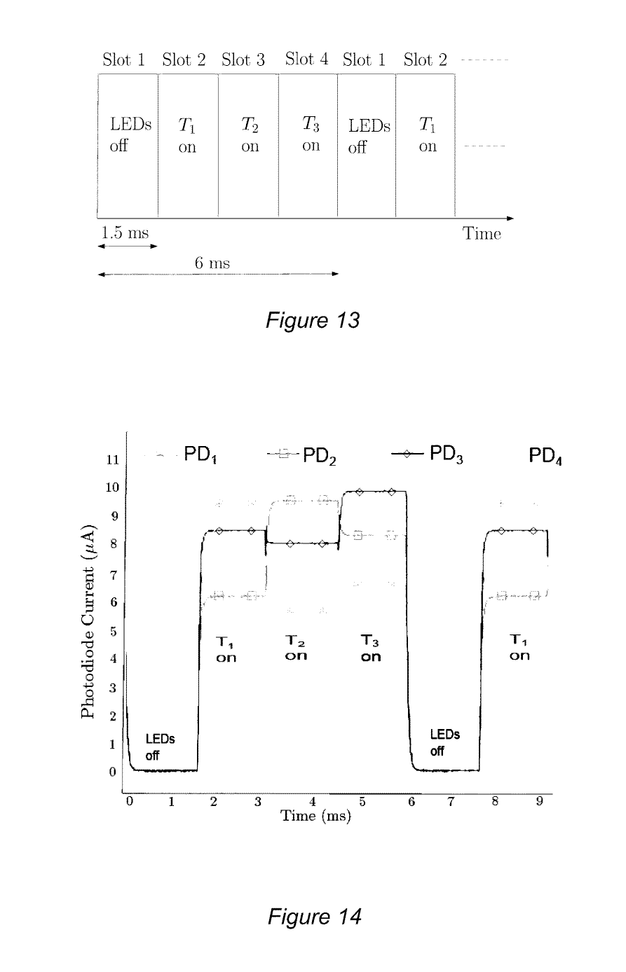

The invention can be applied as an indoor positioning system. An example is shown in FIG. 2. In this example, there are three different light sources 11, 13, 15 (a minimum of two different sources is sufficient) in a room. When a mobile device 17 enters the room, the optical receivers (not shown) of the mobile device 17, acting as effective visible light receiving areas, detect lights from the three different light sources 11, 13, 15. There should a minimal of three optical receivers on the mobile device. The three optical receivers can be positioned at three corners of the mobile device or positioned on a same surface of the mobile device, as long as the light intensity measured by each of the three optical receivers from any one of the three different light sources 11, 13, 15 are different. The three different light sources may produce same light or light of different colour/wavelength. The three different light sources may be controlled centrally so that they transmit at controlled intervals (more discussion later with respect to FIG. 13). The three different light sources may be working independently but pre-programmed to transmit light at different intervals. If the light sources are transmitting different lights, it may be possible for the light sources to transmit light continuously as long as the optical receivers can differentiate different lights from different light sources.

The invention may be implemented by having a mobile device manufactured with at least three optical receivers. Alternatively, the invention can be implemented as a separate module, which can then be attached to a mobile device.

The following presents mathematical analysis to enable a clear understanding of the working of the invention. For this analysis, at least two LED light sources are within the line of sight (LoS) of a receiver. The LED light sources are the transmitters in this system. The receiver is a mobile device equipped with 1 photodiodes (PDs) and an accelerometer. Consider an LED and a photodiode (PD) that are separated by a distance d as shown in FIG. 3. Here, is the irradiance angle with respect to the transmitter's normal and is the incidence angle with respect to the receiver's normal.

The channel gain of a LoS optical wireless channel is given by

$${G}_{LoS} = \frac{( m + 1 ) A}{2 π {d}^{2}} {{cos}^{m} ( φ )}^{T} ( ψ ) ℊ ( ψ ) {cos}^{M} ( ψ ) \qquad ( 1 )$$

where the parameters are explained as follows. The Lambertian parameters of LED and PD given by

$$m = \frac{- log 2}{log ( cos ( {φ}_{1 \text{/} 2} ) )} and M = \frac{- log 2}{log ( cos ( {ψ}_{1 \text{/} 2} ) )} ,$$

where φ_{1/2} is the half-power angle of irradiance of an LED and ψ_{1/2} is the half-power angle of incidence of a PD. The effective area of the photodiode at the receiver is given by A. The filter gain and concentrator gain are represented by T(ψ) and g(ψ), respectively. When the transmitter's optical flux Φ_{T} (in lumens), the received optical power is given by P_{LoS}=Φ_{T}G_{LoS} (in lux·m²). In this system, no filter and concentrator is used at the receiver (i.e., T(ψ)=g(ψ)=1). In this setting, one may assume without the loss of generality that the optical power incident on the photodiode is given by

$${P}_{LoS} = \frac{C}{{d}^{2}} {cos}^{m} ( φ ) {cos}^{M} ( ψ ) \qquad ( 2 )$$

where

$$C {=}^{Δ} \frac{{Φ}_{T} ( m + 1 ) A}{2 π}$$

depends on the physical aspects of the LED and the photodiode, and is independent of the orientation. In this work, it is assumed that the received power from the line-of-sight (LoS) path is dominant, hence (2) will be used to calculate the received power. Note that in this instance, the photometric unit lux·m² is used for power. Physical units lux·m² and Watts are interchangeable and the constant for conversion depends on the device. For the photodiode mentioned in this specification, 1 lux·m²=0.05 W. Other values may be possible.

At the receiver, photodiodes convert the incident optical power to electric current. The average current (in Amperes) generated by a photodiode is

$${μ}_{{I}_{R}} = \frac{{R}_{p} {P}_{LoS}}{A} ,$$

where Rₚ is the responsivity of the photodiode. At the receiver, the received signal is affected by shot noise and thermal noise. Shot noise is the fluctuations in the received signal due to incident optical powers of a desired signal and ambient light source. Thermal noise is the fluctuations in the received signal of the photodiode due to the changes in temperature of the electric circuit of the receiver. The total noise variance (in A²) in optical wireless scenario is σₙₒᵢₛₑ²=σₜₕₑᵣₘₐₗ²+σₛₕₒₜ².

In one embodiment the receiver includes at least three tilted PDs and one accelerometer. The positioning algorithm is based on the received light intensity and the PDs' orientations. In this embodiment, the PDs are arranged in such a way that the distances between them is very small compared with the distance between the photodiodes and the LEDs. In practice, photodiodes are inevitably separated by a small distance (like 1 to 2 cm) due to the size of a photodiode. This small separation can be compensated to improve the accuracy, as discussed in the later part of this specification.

The PDs are tilted by certain elevation angles in the receiver so that different light intensities can be received from the same LED as the received power given in (2) depends on the incidence angle. Since the orientations of the PDs are fixed with respect to the receiver, their orientations can be calculated after the orientation of the receiver is found. If the receiver is static, one can find the orientation of the receiver by using the accelerometer which gives the acceleration along the X, Y and Z coordinates. For example, if the receiver is horizontally placed, then the accelerometer shows that the normal of the receiver is N=[0, 0, 9.8]^{T}. If the receiver is moving, the accelerometer measures the acceleration due to the gravity (and hence, the orientation) along with the linear acceleration due to the movement of the device. Hence, the acceleration due to gravity (and hence, the orientation) is calculated as a difference between accelerometer measurements and linear acceleration measurements. The way to filter out the gravity (and hence, the orientation) is a mature technique.

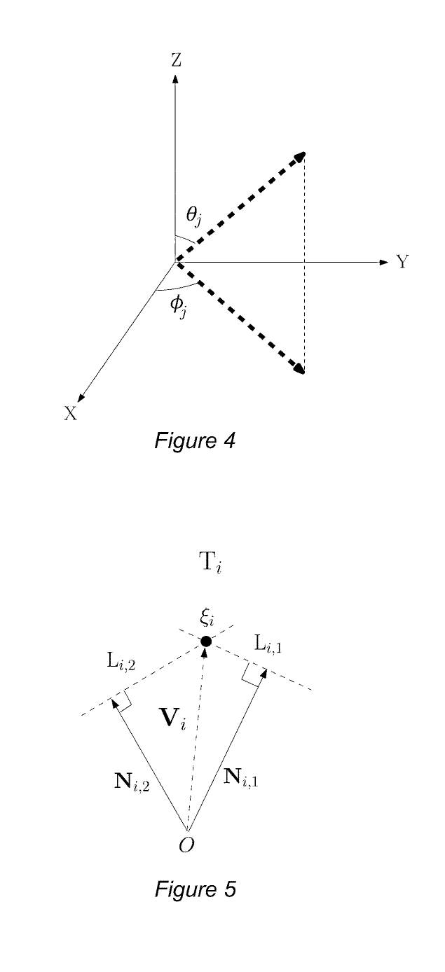

To find the orientation of the PD, first suppose the receiver is placed horizontally, i.e., N=[0, 0, 9.8]^{T}. If the orientation of PD j with respect to the receiver is (θⱼ, φⱼ) in the spherical coordinate system with respect to the receiver as shown in FIG. 4, then the initial orientation (normal) of the photodiode j is

N_{in,j}=[cos φⱼ sin θⱼ sin φⱼ sin θⱼ cos θⱼ]. (3)

If the receiver is not placed horizontally, i.e., N=[Nₓ N_{y} N_{z}]^{T}, then one needs to rotate the initial normal vector N_{in,j} of the photodiode j accordingly. The following focuses on how to calculate the orientations of the PDs from the receiver's orientation (normal vector).

A theorem is proposed (hereinafter “Theorem A”). Consider a receiver with l photodiodes. Let (θⱼ, φⱼ) be the orientation of the photodiode j, for j=1, 2, . . . , l in the spherical coordinate system with respect to the receiver. Define R_{Y}(Ω) as a rotation matrix about the Y-axis, and R_{Z}(Ω) as a rotation matrix about the Z-axis, given as

$$\begin{matrix}{R}_{Y} ( Ω ) = [ \begin{matrix}cos Ω & 0 & sin Ω \\ 0 & 1 & 0 \\ - sin Ω & 0 & cos Ω\end{matrix} ] , & ( 4 ) \\ {R}_{Z} ( Ω ) = [ \begin{matrix}cos Ω & - sin Ω & 0 \\ sin Ω & cos Ω & 0 \\ 0 & 0 & 1\end{matrix} ] . & ( 5 )\end{matrix}$$

Let the unit normal of the receiver obtained from the accelerometer is N=[Nₓ N_{y} N_{z}]^{T}. Let (θ_{N}, φ_{N}) be the orientation of the receiver in the spherical coordinate system, then

Nⱼ=R_{Z}(φ_{N})·R_{Y}(θ_{N})·R_{Z}(−φ_{N})·N_{in,j}. (6)

The novel positioning algorithm uses the received light intensity and the orientation of the PDs to estimate the position of the user. In the following, several modules will be defined and explained. They will be used to define the novel positioning algorithm.

The algorithm first calculates vectors from the receiver towards transmitters and then estimate receiver's coordinates. Suppose k LED light sources are within the LoS of the receiver. The receiver is equipped with l PDs which are tilted to different directions. The origin O of the receiver is defined as the center of the l PDs. In this case, there are l simultaneous measurements of the received power at l different orientations. Using these measurements, for each j=1,2, . . . , l, one can find the vector Vᵢ, i=1,2, . . . , k, which is the vector pointing towards Transmitter Tᵢ from O. Let Oⱼ be the location of the PD j and let Δⱼ=Oⱼ−O be a shift vector.

Considered a special case that |Δ|ⱼ|=0 for all j. In this special case, the vector Vᵢ can be found as follows. Let N_{i,j} [symbol] [a_{i,j} b_{i,j} c_{i,j}]^{T} be the normal vector of the photodiode j calculated by using Theorem A with

$$\vert {N}_{i , j} \vert = {P}_{j , i}^{\frac{1}{M}}$$

where P_{j,i} is the received power in PD j from LED i. Let L_{i,j}, j=1,2, . . . , l be the plane perpendicular to vector N_{i,j} that passes through the ending point of N_{i,j}. These l planes for the Transmitter Tᵢ are specified as L_{i,j}: a_{i,j}X+b_{i,j}Y+c_{i,j}Z=δ_{i,j}, j=1, . . . , l. In the noiseless case, all planes intersect at one point which is denoted by j. Then the vector Vᵢ is the vector starting from O and ending in ξᵢ. Due to the presence of noise, is approximated by the point closet to the l planes L_{i,j} for j=1, . . . , l. So the vector Vᵢ is approximated by the \hat{V}ᵢ which can be found using the method presented in Yasir et al., “Indoor positioning system using visible light and accelerometer”, IEEE/OSA Journal of Lightwave Technology, July 2014. The special case |Δ|ⱼ|=0 is shown in FIG. 5.

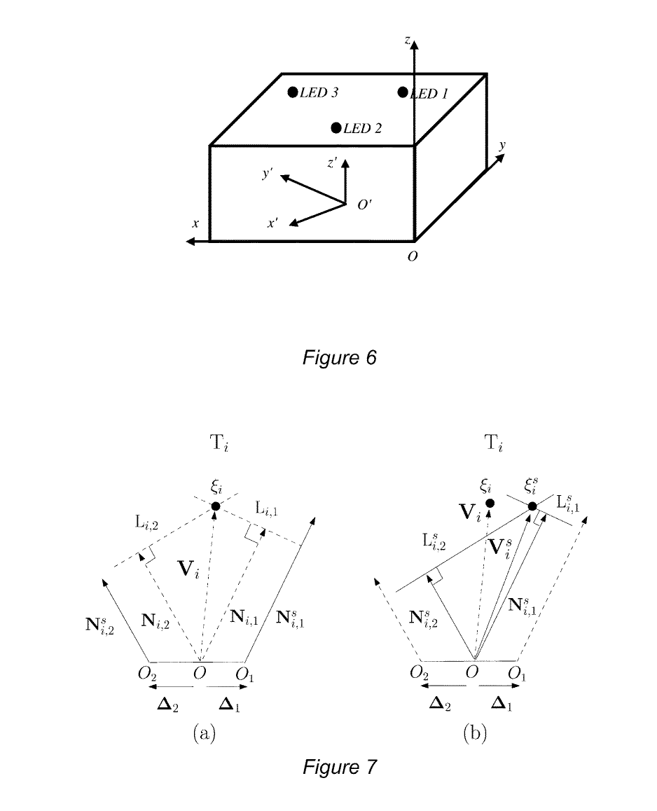

The next module is used to solve the problem that the coordinate system of the receiver may not match the coordinate system of the room as shown in FIG. 6. The Z-axis can be aligned easily by using the accelerometer. However, the X- and Y-axes of the receiver can be arbitrarily relative to the X- and Y-axes of the room. Therefore, the vectors \hat{V}ᵢ for i=1,2, . . . , k, which are the estimated vectors pointing towards each transmitter (from the receiver), are obtained according to the receiver's coordinate system. Hence, a suitable rotation is needed to align the two coordinate systems before computing receiver's position. Let θθ* be the rotation angle requires to align the two coordinate systems. The rotated vector \hat{V}_{θθ}*_{,i}, i=1,2, . . . , k is given as

\hat{V}_{θθ}*_{,i}=R_{Z}(θθ*)·\hat{V}_{i,}, i=1,2, . . . , k. (7)

After computing i=1,2, . . . , k, one can estimate the position of the receiver which is described as follows:
1. Suppose \hat{V}_{θθ}*_{,i} [symbol] [x_{0,i} Y_{0,l} z_{0,i}]^{T}, i=1,2, . . . , k is the estimated rotated vector (from the Receiver R towards Transmitter Tᵢ).
2. Let hᵢ=[xᵢ yᵢ zᵢ]^{T} be the location of i^{th} Transmitter.
3. Let yᵢ, i=1,2, . . . , k be the ray parallel to \hat{V}_{θθ}*_{,i} and passing through hᵢ.
4. The estimate of the receiver's position Ŝ=[sₓ s_{y} s_{z}]^{T} is defined as the solution to the following minimization problem

$${arg min}_{( {s}_{x} , {s}_{y} , {s}_{z} )} {Σ}_{i = 1}^{k} {d}_{min}^{2} [ ( {s}_{x} , {s}_{y} , {s}_{z} ) , {γ}_{i} ] \qquad ( 8 )$$

where dₘᵢₙ²[(sₓ, x_{y}, s_{z}), γᵢ] denotes the minimum distance between ray γᵢ and (sᵣ, s_{y}, s_{z}). Note that this is a general convex quadratic minimization problem since dₘᵢₙ²[(sₓ, s_{y}, s_{z}), γᵢ] is a linear function of the (sₓ, s_{y}, s_{z}). To identify dₘᵢₙ²[(sₓ, s_{y}, s_{z}), γᵢ], one needs to find a point on the ray γᵢ such that the distance square between γᵢ and (sₓ, s_{y}, s_{z}) is minimized. Let the i^{th} ray be given as γᵢ=hᵢ+tᵢ\hat{V}_{θθ}*_{,i}, where the parameter tᵢ minimizes the square distance between any point w ∈ [symbol] ³ and a ray γᵢ. For any w ∈ [symbol] ³, the point P_{close,i}[w] on the ray yᵢ that is closest to w is given by

P_{close,i}[w]=Bᵢw+Dᵢ (9)

where Bᵢ and Dᵢ are given as

$$\begin{matrix}{B}_{i} = \frac{1}{\vert \vert {\hat{V}}_{{ϑ}^{*} , i} {\vert \vert}^{2}} [ \begin{matrix}{x}_{0 , i}^{2} & {x}_{0 , i} {y}_{0 , i} & {x}_{0 , i} {z}_{0 , i} \\ {x}_{0 , i} {y}_{0 , i} & {y}_{0 , i}^{2} & {y}_{0 , i} {z}_{0 , 1} \\ {x}_{0 , i} {z}_{0 , i} & {y}_{0 , i} {z}_{0 , i} & {z}_{o , i}^{2} \end{matrix} ] , & ( 10 ) \\ {D}_{i} = \frac{1}{\vert \vert {\hat{V}}_{{ϑ}^{*} , i} {\vert \vert}^{2}} [ \begin{matrix}{x}_{i} \vert \vert {\hat{V}}_{{ϑ}^{*} , i} {\vert \vert}^{2} - {x}_{i} {x}_{0 , i}^{2} - {y}_{i} {x}_{0 , i} {y}_{0 , i} - {z}_{i} {x}_{0 , i} {z}_{0 , i} \\ {y}_{i} \vert \vert {\hat{V}}_{{ϑ}^{*} , i} {\vert \vert}^{2} - {y}_{i} {y}_{0 , i}^{2} - {x}_{i} {x}_{0 , i} {y}_{0 , i} - {z}_{i} {y}_{0 , i} {z}_{0 , i} \\ {z}_{i} \vert \vert {\hat{V}}_{{ϑ}^{*} , i} {\vert \vert}^{2} - {z}_{i} {z}_{0 , i}^{2} - {x}_{i} {x}_{0 , i} {z}_{0 , i} - {y}_{i} {y}_{0 , i} {z}_{0 , i}\end{matrix} ] . & ( 11 )\end{matrix}$$

Equivalently, the optimization problem in (8) can be formulated as

$$\begin{matrix}{arg min}_{\hat{s}} {\sum }_{i = 1}^{k} {‖ {P}_{close , i } [ \hat{S} ] - \hat{S} ‖}^{2 } , \\ where & ( 12 ) \\ \begin{matrix}{‖ {P}_{close , i } [ \hat{S} ] - \hat{S} ‖}^{2 } = {‖ ( {B}_{i} - {I}_{3} ) \hat{S} + {D}_{i} ‖}^{2} \\ = 2 {D}_{i}^{T } ( {B}_{i} - {I}_{3} ) \hat{S} + \\ {{\hat{S}}^{T} ( {B}_{i} - {I}_{3} )}^{T } ( {B}_{i} - {I}_{3} ) \hat{S} + \\ {D}_{i}^{T} {D}_{i} ,\end{matrix} & ( 13 )\end{matrix}$$

where l₃ is the 3×3 identity matrix. The solution to the problem in (8) is as follows (hereinafter “Definition A”): Let γᵢ, i=1,2, . . . , k be the infinite ray parallel to \hat{V}_{θθ}*_{,i} and passing through hᵢ. Define the vector Ŝ=[sₓ s_{y} s_{z}]^{T} to be the solution to the minimization problem of (8). Then

$${\hat{S} ( {\sum }_{i = 1}^{k} ( {𝕀}_{3} - {B}_{i} ) )}^{- 1} ( {\sum }_{i = 1}^{k} ( {𝕀}_{3} - {B}_{i} ) {h}_{i} ) ) ,$$

where Bᵢ is defined by (10) and hᵢ is the location of i^{th} Transmitter.

The multiple photodiodes based indoor positioning (MPIP) algorithm gives an estimate of the position of the receiver by aligning the two coordinate systems. Note that θθ* is the rotation angle to align the two coordinate systems. One first needs to rotate the estimated vectors \hat{V}ᵢ, i=1,2, . . . , k by θθ* degrees about Z-axis, then the receiver's position is estimated using Definition A.

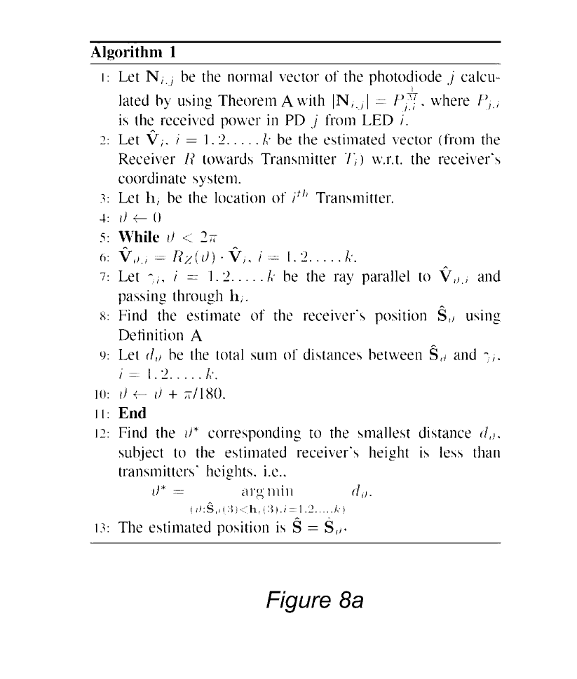

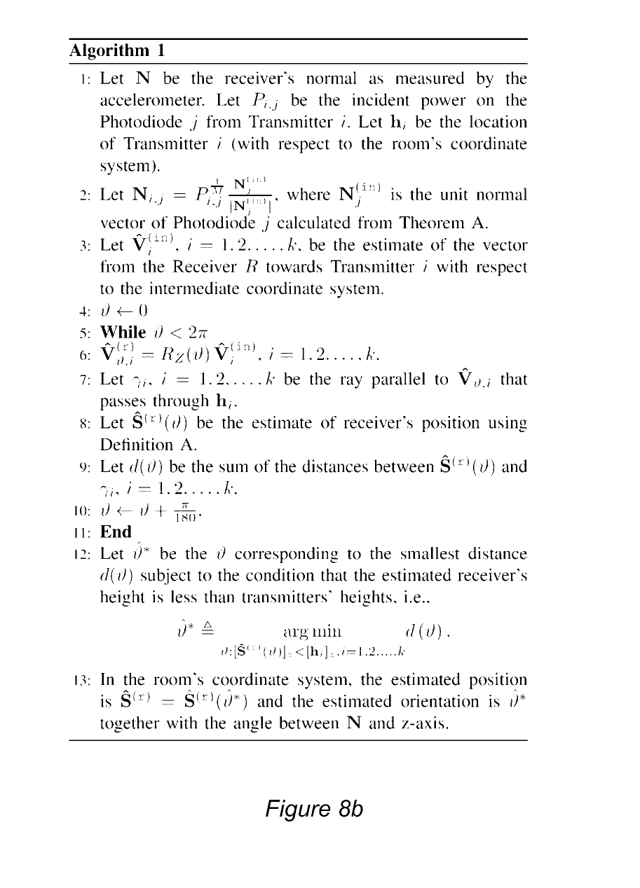

FIG. 8a shows Algorithm 1 (MPIP) which gives an estimate of the user's position by assuming that all the photodiodes are placed at the same location, i.e., |Δ|ⱼ|=0. Since, in practice the photodiodes are inevitably separated by a small distance, i.e., |Δ|ⱼ|≠0, one needs to generalize the method for finding Vᵢ when |Δ|ⱼ|>0. Let N_{i,j}^{s} be the normal vector N_{i,j} shifted to the position O_{f} as shown in FIG. 7(a). Note that when |Δ|ⱼ|≠0, the magnitude of the normal vector of the photodiode j, i.e., |N_{i,j}^{s}| either increases or decreases by a small value, depending on whether the photodiode is moved towards the LED or away from the LED. If we ignore this difference in the magnitude of the normal vectors and assumes that the photodiodes are at the same position O, and estimate the vector Vᵢ^{s} using methods in Algorithm 1, then the estimated vector is slightly different from the actual vector Vᵢ, which is the vector when |Δ|ⱼ|=0 as shown in FIG. 7(b). Note that this introduces a small error in the estimated vector. Hence, the position estimated using Algorithm 1 can be improved, because Algorithm 1 is based on an assumption that all photodiodes are at same position which is not valid in realistic scenarios. In the following, it is explained how to compensate this error. FIG. 8b shows an alternative of Algorithm 1.

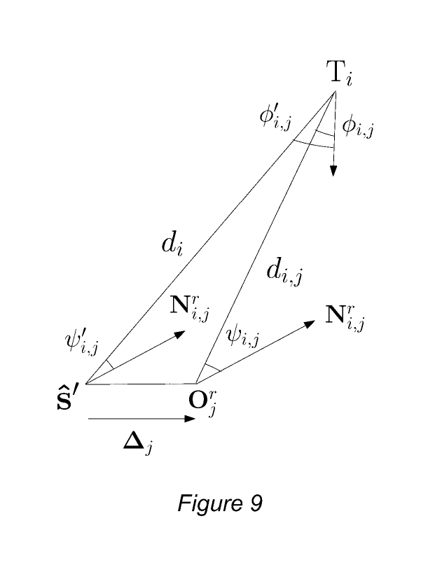

Consider a transmitter and a receiver shown in FIG. 9. To compensate the error in the estimated vector Vᵢ^{s}, the magnitude of the normal vector of photodiode j, i.e., |N_{i,j}^{s}| needs to be adjusted before computing the vector from the receiver towards each transmitter. Let Ŝ′ be the estimated position of the receiver calculated using Algorithm 1. Once the estimated position of the receiver Ŝ′ is known, we can find the corresponding position of the photodiode j, after that we can find the ratio of the received powers at photodiode's location and at the center of the receiver (assuming ideally all PDs should be at the center of the receiver). This ratio is defined as a power compensation parameter ρ_{i,j}. Theorem B below gives the position and orientation of the photodiode j which will be required to find the power compensation parameter ρ_{i,j}.

Theorem B: Consider a receiver with l photodiodes. Let (θ_{N}, φ_{N}) be the orientation of the receiver in the spherical coordinate system and let Δⱼ be the initial position vector of the photodiode j w.r.t the receiver. Let θθ* be the mismatch angle between the receiver's coordinate system and the room's coordinate system, then the corresponding position of the photodiode j w.r.t the room's coordinate system is

Oⱼ^{r}=R_{Z}(θθ*)·R_{Z}(φ_{N})·R_{Y}(θ_{N})·R_{Z}(−φ_{N})·Δⱼ. (14)

The normal vector of the photodiode w.r.t the room's coordinate system is given by

N_{i,j}^{r}=R_{Z}(θ*)·N_{i,j}^{s}. (15)

Once the position and the orientation of the photodiode j is known, the ratio of the receiver powers can be found. The received power of the photodiode j is given by

$${P}_{i , j}^{s} = \frac{C}{{d}_{i , j}} {cos}^{m} ( {φ}_{i , j} ) {cos}^{M} ( {ψ}_{i , j} ) = \frac{C}{{\vert {h}_{i} - {O}_{j}^{r} \vert}^{2}} {( \frac{( {h}_{i} - {O}_{j}^{r} ) \cdot {[ \begin{matrix}0 & 0 & 1\end{matrix} ]}^{T}}{\vert {h}_{i} - {O}_{j}^{r} \vert} )}^{m} {( \frac{( {h}_{i} - {O}_{j}^{r} ) \cdot {N}_{i , j}^{r}}{\vert {h}_{i} - {O}_{j}^{r} \vert \vert {N}_{j}^{r} \vert} )}^{M} . \qquad ( 16 )$$

Similarly, the received power at the center of the receiver (assuming this should be the correct position of the PD) is given by

$${P}_{i , j}^{′} = \frac{C}{{d}_{i}} {cos}^{m} ( {φ}_{i , j}^{′} ) {cos}^{M} ( {ψ}_{i , j}^{′} ) = \frac{C}{{\vert {h}_{i} - {\hat{S}}^{′} \vert}^{2}} {( \frac{( {h}_{i} - {\hat{S}}^{′} ) \cdot {[ \begin{matrix}0 & 0 & 1\end{matrix} ]}^{T}}{\vert {h}_{i} - {\hat{S}}^{′} \vert} )}^{m} {( \frac{( {h}_{i} - {\hat{S}}^{′} ) \cdot {N}_{i , j}^{r}}{\vert {h}_{i} - {\hat{S}}^{′} \vert \vert {N}_{i , j}^{r} \vert} )}^{M} . \qquad ( 17 )$$

The power compensation factor ρ_{i,j} is given by

$${ρ}_{i , j} = \frac{{P}_{i , j}^{′}}{{P}_{i , j}^{S}} . \qquad ( 18 )$$

The magnitude of the normal vector of the photodiode j for transmitter i can be adjusted as

$$\vert {N}_{i , j} \vert = {( {ρ}_{i , j} )}^{\frac{1}{M}} \vert {N}_{i , j}^{s} \vert . \qquad ( 19 )$$

Once the magnitudes of the normal vectors are adjusted from |N_{i,j}^{s}| to |N_{i,j}|, the photodiodes are hypothetically considered to be placed at the same position O. Hence, the estimated vector \hat{V}ᵢ, which is the vector from the receiver towards each LED is given by

$${\hat{V}}_{i} = - {( {\sum }_{j = 1}^{l} {E}_{i , j}^{T} {E}_{i , j} )}^{- 1} ( {\sum }_{j = 1}^{l} {( {ρ}_{i , j} )}^{\frac{1}{M}} {E}_{i , j}^{T} {F}_{i , j} ) , \qquad ( 20 )$$

where E_{i,j} and F_{i,j} are defined as

$$\begin{matrix}{E}_{i , j} {=}^{Δ} {\frac{- 1}{{a}_{i , j}^{2} + {b}_{i , j}^{ 2} + {c}_{i , j}^{2}} [ \begin{matrix}{a}_{i , j} & {b}_{i , j} & {c}_{i , j}\end{matrix} ]}^{T} [ \begin{matrix}{a}_{i , j} & {b}_{i , j} & {c}_{i , j}\end{matrix} ] & ( 21 ) \\ {F}_{i , j} {=}^{Δ} {\frac{{δ}_{i , j}}{{a}_{i , j}^{2} + {b}_{i , j}^{2} + {c}_{i , j}^{2}} [ \begin{matrix}{a}_{i , j} & {b}_{i , j} & {c}_{i , j}\end{matrix} ]}^{T} . & ( 22 )\end{matrix}$$

Once the estimated vector \hat{V}ᵢ is corrected using power correction factor ρ_{i,j}, then the estimated receiver's position Ŝ′ can be further refined to Ŝ by using Algorithm 2. The improved multiple photodiodes based indoor positioning (IMPIP) algorithm gives an estimate of the position of the receiver using the power correction factor ρ_{i,j}. Similar to MPIP, θθ* is the rotation angle to align the two coordinate systems. We first need to rotate the estimated vectors \hat{V}ᵢ=1,2, . . . , k by θθ* about Z-axis, then the receiver's position is estimated using Definition A.

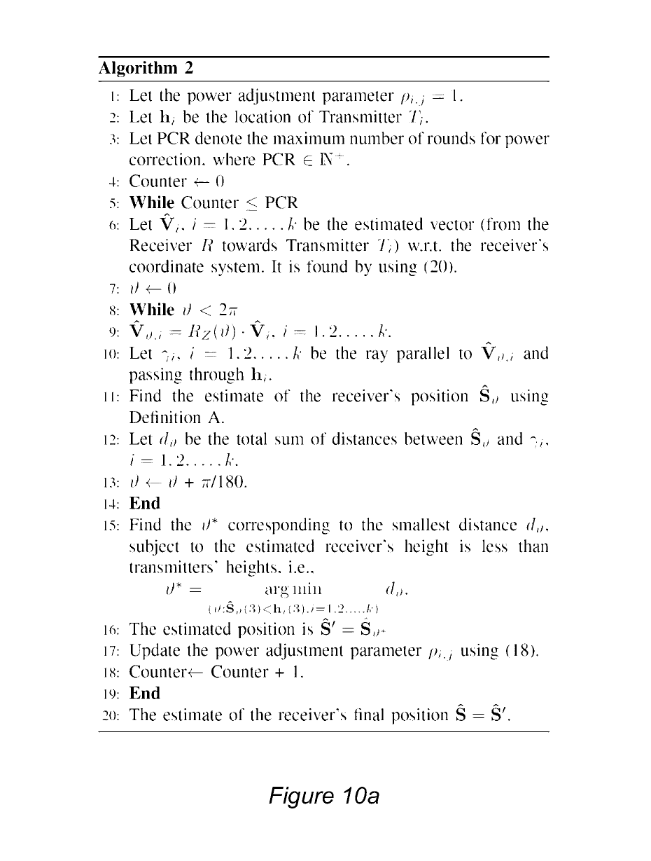

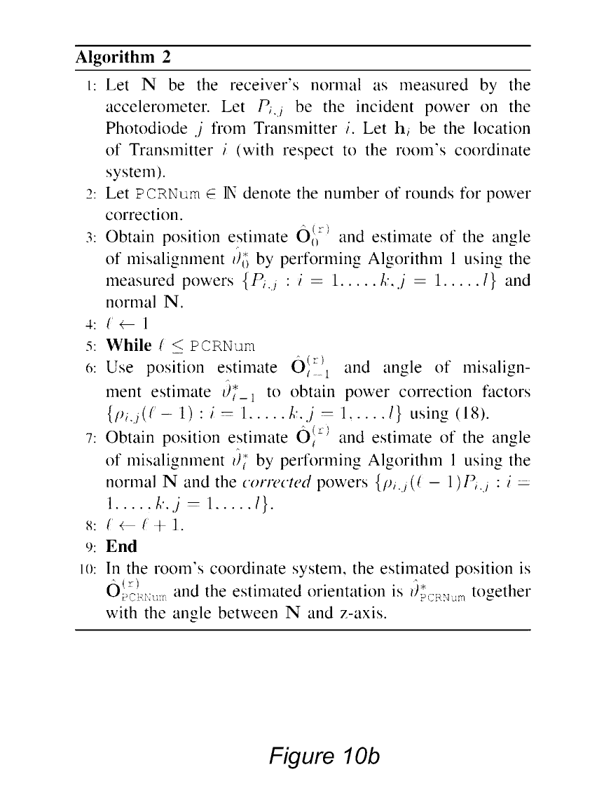

FIG. 10a shows Algorithm 2 (IMPIP) as the improved algorithm. Results show that three rounds for power correction are enough to achieve the zero position error in the noiseless case, i.e., when PCR→3, Error→0. FIG. 10b shows an alternative of Algorithm 2.

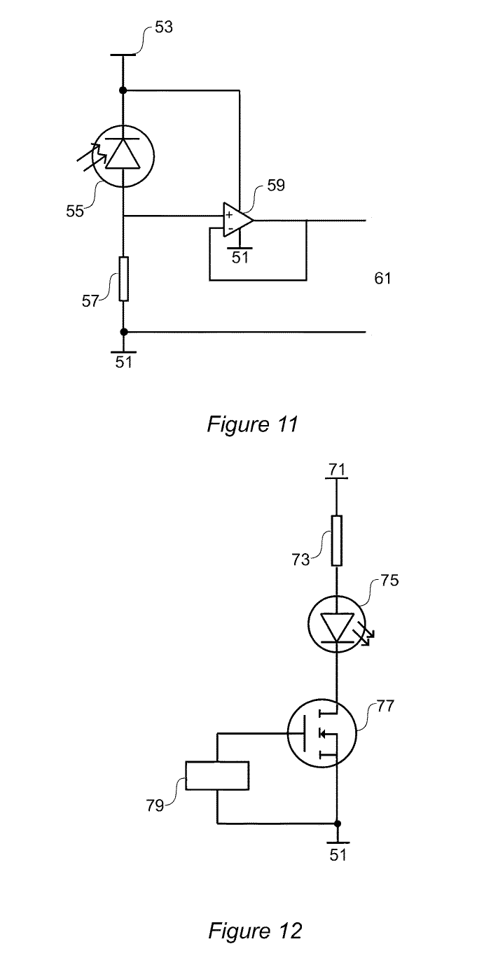

In an experimental setup, three LEDs are mounted on the ceiling. The LEDs coordinates (in m) are: (2.37, 1.81, 2.7), (1.10, 0.88, 2.7) and (1.12, 1.81, 2.7). The size of the room is 5m length, 4m breadth and 3m height. Bridgelux LEDs (BXRA-56C5300-H-00) are used as transmitters. The typical luminous flux of each LED is Φ=6000 lm. Four photodiodes are placed on a pyramid structure. In one positioning algorithm, it is not necessary to have same elevation angles for all photodiodes used. However, in the experiments, the same elevation angle is used which in radian is 23π/180. The choice of these angles is arbitrary, however, they should be selected in such a way that the photodiodes lie in the line of sight of the LEDs. Centronic Silicon photodetector is used to measure the light intensity. The responsivity of each photodiode is 22 nA/lux and its effective area is 15 mm². The Lambertian parameter of the photodiode was experimentally found to be M=1.4, and the field of view is 1.22 rad. FIG. 11 and FIG. 12 show an example of the circuits of the receiver and the transmitter respectively. In FIG. 11, the exemplary single receiver circuit includes a power supply 53, resistor 57, photodiode 55, amplifier 59, ground 51 and output 61. To have three effective visible light receiving areas, one can use three standard photodiodes, for example OSD15-E, in three circuits identical to that of FIG. 11. Of course, the parts or circuits can be different, as long as the three effective visible light receiving areas provide three different measurements of light intensity of a light from the same light source. In FIG. 12, the exemplary single transmitter circuit includes a power supply 71, resistor 73, LED 75 (for example BXRA-50C5300), FET 77, data acquisition unit (for example USB-6341) 79 and ground 51.

The output of each photodiode is also affected by both shot and thermal noises. The noise model derived experimentally using Centronic Silicon photodetector is used. This model was derived by measuring the means and variances of noise for various incident optical fluxes:

$${σ}_{{noise}_{i , j}}^{2} = {σ}_{thermal}^{2} + {σ}_{{shot}_{i , j}}^{2} = 8.0185 \times {10}^{- 18} + 1.869 \times {10}^{- 11} {μ}_{{I}_{{R}_{i , j}}} , \qquad ( 23 )$$

where μₗ_{_{Ri,j}} is the output current generated by photodiode j using Transmitter i. The accelerometer of the mobile phone (Samsung Galaxy Note N7000) is placed on the receiver to find the orientation of the receiver, i.e., the normal vector N of the receiver. In a mobile scenario, the orientation of the receiver is calculated by subtracting linear acceleration from the accelerometer measurements. The orientations of the photodiodes (normal vectors) in a first coordinate system are calculated using Theorem A. To estimate the noise variance of the accelerometer, we place it on a fixed surface and measure the orientation using the device. From extensive measurements, the variance of the accelerometer noise was found to be 5.6918×10⁵ (m/s²)².

A Time Division Multiple Access (TDMA) scheme is implemented for LEDs as is illustrated in FIG. 13; this scheme is used to identify the received power from each transmitter separately. This TDMA scheme is implemented using LabVIEW and National Instruments Data Acquisition (DAQ) box USB-6341. LEDs are controlled using the digital ports of the DAQ device. The output of each photodiode is also connected to analog port of the DAQ device. In this TDMA scheme, each cycle is divided into four time slots. The first time slot is used to estimate the background light intensity so that all LEDs are off The remaining slots are used to measure the light intensity from each transmitter separately. The duration of each cycle is 6 ms. Let φhd i, 1≦i≦3 be the transmit optical flux of the Transmitter Tᵢ when it is on, then the received power of photodiode j during n^{th} slot for n=1,2,3 and j=1, . . . , 4 is calculated as

P_{LoS}_{_{j,n}}=λ_{n,j}ΦₙP_{background}, (24)

where λ_{i,j}, n=1,2,3 and j =1, . . . , 4 is the corresponding path loss term corresponding to the Transmitter Tᵢ and photodiode j pair. For each slot n=1,2,3,4, samples of the photodiode output I_{R}_{_{j,n}} are measured using the DAQ device. Note that the average current generated by photodiode j is

$${μ}_{{I}_{{R}_{j , n}}} = {R}_{p} \frac{{P}_{{LoS}_{j , n}}}{A} .$$

### Hence,

$$( {μ}_{{I}_{{R}_{j , n}}} - {μ}_{{I}_{{R}_{j , 1}}} ) = {R}_{p} \frac{( {P}_{{LoS}_{j , n}} - {P}_{background} )}{A}$$

is used as the estimate of the light intensity for photodiode j. FIG. 14 illustrates a typical output of the four photodiodes in TDMA scenario.

Of course, besides TDMA, it is possible to apply other methods, for example CDMA, to identify the received power from each transmitter separately.

Simulation was conducted based on the algorithm presented herein in a typical room scenario where the three transmitters are located at (1,4,3), (4,1,4) and (4,4,5). The receiver is located at (2,2,1). Simulation parameters are: LED half power-angle

$${φ}_{1 / 2} = \frac{π}{3} ,$$

PD's Lambertian parameter M=1.4, PD's responsivity Rₚ=22 nA/lux, and receiver's area is A=15 mm². The mismatch angle between the room's coordinate system and the mobile's coordinate system is assumed to be π/2 rad. It is assumed that the transmitters each have the same luminous flux, and assume the mean current generated by light from Transmitter Tᵢ to be

$${μ}_{{I}_{{R}_{i}}} = \frac{{R}_{p} {P}_{{LoS}_{i}}}{A} ,$$

where P_{LoS}_{ᵢ} is computed using (2). It is assumed that the photodiode is affected by both shot and thermal noises whose variance is given by (23). It is also assumed that the accelerometer measurements of acceleration due to gravity are affected by noise variance σ_{N}².

Let N be the normal vector of the receiver with magnitude equal to the acceleration due to gravity g=9.8 m/s². In this simulation, it is assumed N=[2 3.32 9]^{T}. Due to the noise in the photodiode and the accelerometer, the measured normal vector and generated current for i=1,2,3 and j=1,2, . . . , l are

$$\begin{matrix}\hat{N} = N + ( {E}_{j}^{x} , {E}_{j}^{y} , {E}_{j}^{z} ) & ( 25 ) \\ {I}_{{R}_{i , j}} = {μ}_{{I}_{{R}_{i , j}}} + {E}_{i , j} = {R}_{p} \frac{{P}_{{LoS}_{i , j}}}{A} + {E}_{i , j} , & ( 26 )\end{matrix}$$

where (Eⱼ^{x}, Eⱼ^{y}, Eⱼ^{z})˜ [symbol] (0, σ_{N}²I₃) represents the accelerometer noise, and E_{i,j}˜ [symbol] (0, σₙₒᵢₛₑ_{_{i,j}}²) represents the noise in the photodiode j due to light from Transmitter i. In these simulations, we assume that photodiodes are distributed uniformly and circularly on a pyramidal receiver with |Δⱼ|=0.02 m, for all j=1, 2, . . . , l. The elevation angle of each photodiode is 5π/36 rad, where as the azimuth angles are selected based on the number of photodiodes such that the difference between any two consecutive angles is the same, e.g., for the receiver with 4 photodiodes, azimuth angles in radians are (0, π/2, π, 3π/2).

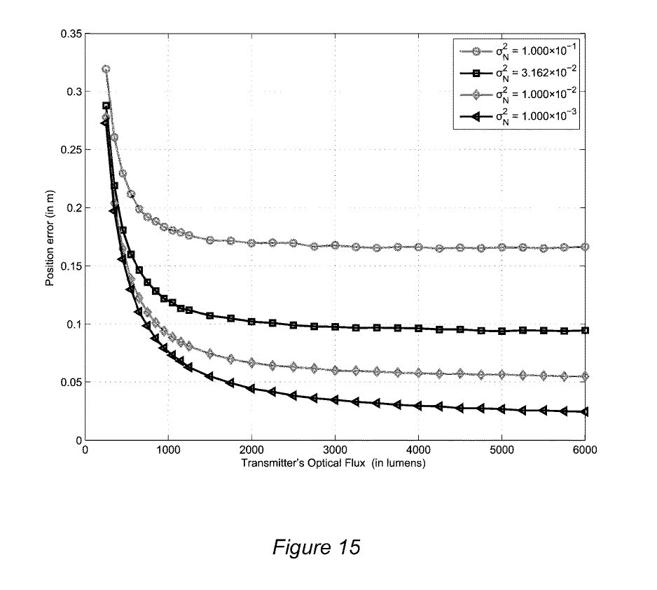

In the following summation results, we define position error as a distance between the actual position and the estimated position. FIG. 15 presents the simulation results for position errors for different values of the luminous flux emitted by the LEDs and σ_{N}². Each point in FIG. 15 is generated by running the simulation 10000 times. In this simulation, the receiver consist of three photodiodes. Note that the position error drops with the increase of luminous flux. However, the positioning accuracy also depends on the variance of the accelerometer noise. it is also noted that if the accelerometer measurements are noisy, then even for higher luminous flux, the position error increase up to 0.17 m. FIG. 15 shows that for luminous flux greater than 1000 lm and σ_{N}²≧1.000×10⁻², position error of less than 0.1 m is achievable.

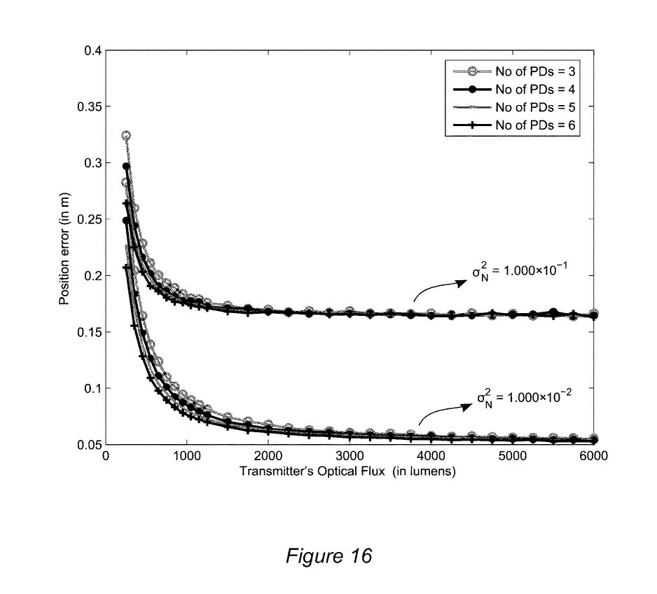

FIG. 16 presents the simulation results for position errors for different values of the luminous flux emitted by the LEDs. The result shows that the position error also depends on the number of photodiodes, i.e., position error decreases with the increase in the number of photodiodes. However, this improvement in position error is significant in lower luminous flux range. The figure is showing results for the two noise variances of the accelerometer, i.e., σ_{N}²=1.00×10⁻¹, and σ_{N}²=1.00×10⁻².

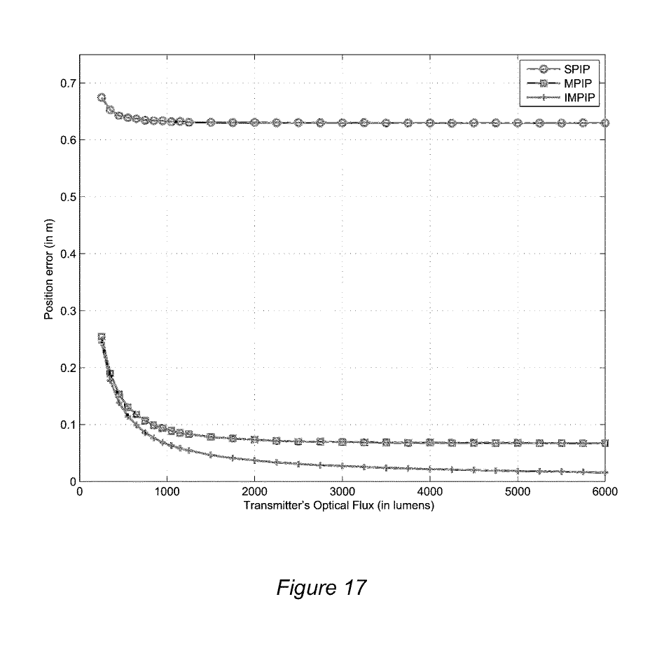

FIG. 17 compares single photodiode based indoor positioning (SPIP) algorithm proposed in Yasir et al., “Indoor positioning system using visible light and accelerometer”, IEEE/OSA Journal of Lightwave Technology, July 2014 with the proposed multiple photodiodes based indoor positioning (MPIP) algorithm proposed herein. For SPIP, it is to simulate different receiver's normal by merely rotating the photodiode at different orientations. This is equivalent to multiple photodiodes but with different tilt angles. In this figure, the variance of accelerometer noise is assumed to be σ_{N}²=3.162×10⁻⁵, the number of photodiodes are considered to be 4. The figure shows that MPIP performs much better than SPIP. The figure also shows the benefit of using power correction parameter ρ_{i,j}. The figure compares the position error with and without power correction. The improvement in the positioning accuracy is due the reason that when photodiodes are separated by a small distance, the estimated vector from the receiver towards the transmitter is not very accurate. This small separation is handled in our proposed algorithm using power correction parameter ρ_{i,j} to improve the positioning accuracy.

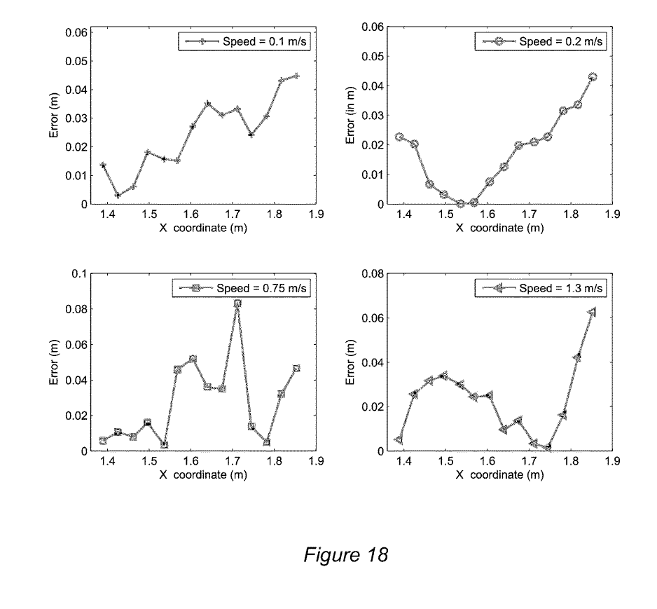

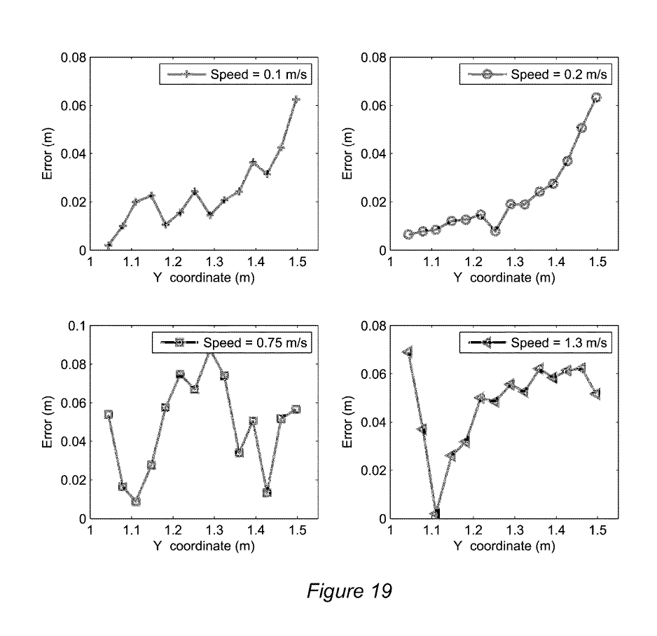

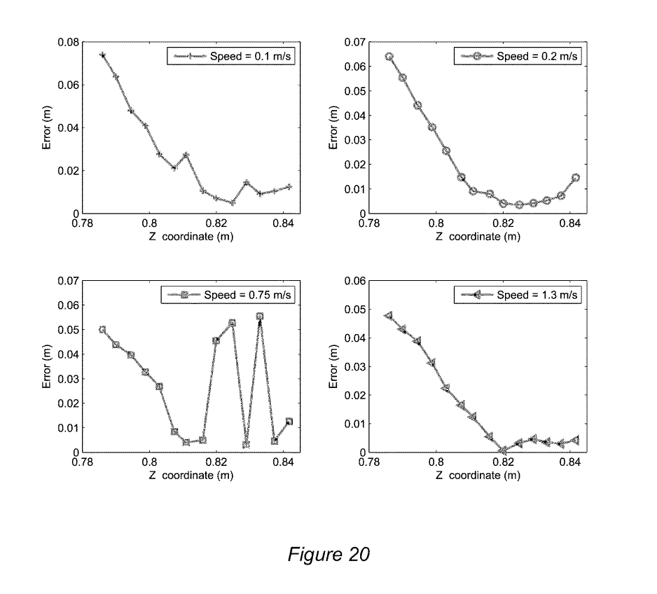

To study the effect of receiver motion on the proposed algorithm's performance, we move the receiver on a tilted surface in such a way that all three coordinates X, Y, and Z change with the movement of the receiver. We tested our system by varying the speed of the receiver from 0.1 m/s to 1.3 m/s. FIG. 18 presents the error between X-coordinate and estimated X-coordinate of the receiver for different speeds. Similarly, FIGS. 19 and 20 present the error between actual Y-coordinate and Z-coordinate and estimated Y-coordinate and Z-coordinate of the receiver. Note that the error is not increasing with the speed of the receiver. This is due to the reason that most of the Smartphones available today use sophisticated algorithms to estimate linear acceleration of the mobile. Hence, the orientation calculated by subtracting linear acceleration from the accelerometer measurements is also very accurate. However, the orientation also depends on the range of the accelerometer, e.g., if the accurate accelerometer measurements is (−2 g, 2 g), where 0 g corresponds to free fall, and the actual acceleration of the receiver exceeds from this range, then the estimated orientation will be incorrect. The range of accurate accelerometer measurements varies from (−1.2 g, 1.2 g) to (−500 g, 500 g) depending on the accelerometer itself. Most of the Smartphones available today have the minimum range of (−2 g, 2 g), which is enough to handle mobility of the user in indoor scenarios.

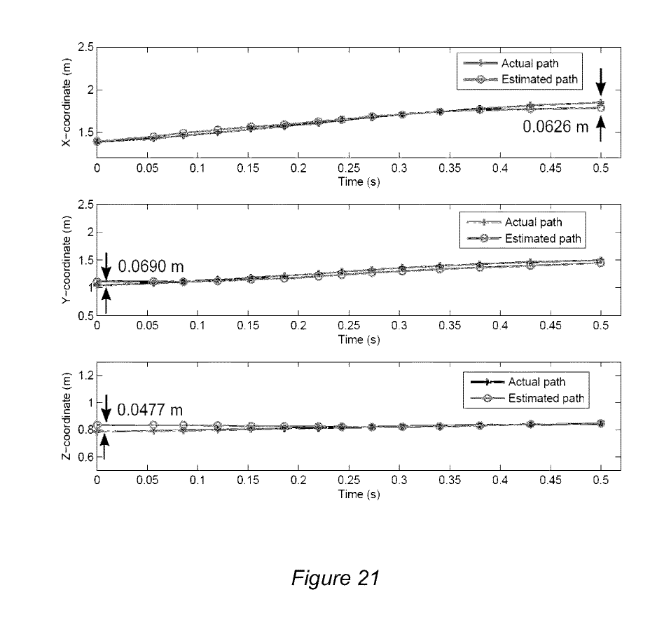

FIG. 21 shows the differences between the actual and estimated path when the receiver was moving with the speed of 1.3 m/s. Note that the estimated path closely follows the true path.

The present invention enables an indoor positioning system using multiple optical receivers. The proposed system is not costly as it uses LEDs as transmitters, and photodiodes and accelerometers at the receivers, which are readily available in today's Smartphones. The proposed system has low complexity and position is estimated at the receiver side, hence there are no privacy concerns associated with this system. Simulation results shows that in typical scenario, a minimum of three photodiodes is enough to achieve the positioning accuracy of less than 0.1 m. Exhaustive experimentations have been done to evaluate the tracking ability of our algorithm. Results show that in realistic scenarios, position error of less than 0.1 m is achievable and the average position error is less than 0.06 m.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software or instructions, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM, a Blu-ray disc, or any other form of computer readable medium. In some aspects the computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media. In another aspect, the computer readable medium may be integral to the processor. The processor and the computer readable medium may reside in an ASIC or related device. The software codes may be stored in a memory unit and the processor may be configured to execute them. The memory unit may be implemented within the processor or external to the processor, in which case it can be communicatively coupled to the processor via various means as is known in the art.

Further, it should be appreciated that modules and/or other appropriate means for performing the methods and techniques described herein can be downloaded and/or otherwise obtained by computing device. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a computing device can obtain the various methods upon coupling or providing the storage means to the device. Moreover, any other suitable technique for providing the methods and techniques described herein to a device can be utilized.

In one form the invention may comprise a computer program product for performing the method or operations presented herein. For example, such a computer program product may comprise a computer (or processor) readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The system may be a computer implemented system comprising of a display device, a processor and a memory and an input device. The memory may comprise instructions to cause the processor to execute a method described herein. The processor memory and display device may be included in a standard computing device, such as a desktop computer, a portable computing device such as a laptop computer or tablet, or they may be included in a customised device or system. The computing device may be a unitary computing or programmable device, or a distributed device comprising several components operatively (or functionally) connected via wired or wireless connections. An embodiment of a computing device 100 is illustrated in FIG. 1 and comprises a central processing unit (CPU) 110, a memory 120, a display apparatus 130, and may include an input device 140 such as keyboard, mouse, etc. The CPU 110 comprises an Input/Output Interface 112, an Arithmetic and Logic Unit (ALU) 114 and a Control Unit and Program Counter element 116 which is in communication with input and output devices (eg input device 140 and display apparatus 130) through the Input/Output Interface. The Input/Output Interface may comprise a network interface and/or communications module for communicating with an equivalent communications module in another device using a predefined communications protocol (e.g. Bluetooth, Zigbee, IEEE 802.15, IEEE 802.11, TCP/IP, UDP, etc). A graphical processing unit (GPU) may also be included. The display apparatus may comprise a flat screen display (eu, LCD, LED, plasma, touch screen, etc), a projector, CRT, etc. The computing device may comprise a single CPU (core) or multiple CPU's (multiple core), or multiple processors. The computing device may use a parallel processor, a vector processor, or be a distributed computing device. The memory is operatively coupled to the processor(s) and may comprise RAM and ROM components, and may be provided within or external to the device. The memory may be used to store the operating system and additional software modules or instructions. The processor(s) may be configured to load and executed the software modules or instructions stored in the memory.

1. A method for enabling indoor positioning of a mobile receiver, including:
detecting an orientation of the mobile receiver relative to a first coordinate system;
measuring light intensities using at least three effective visible light receiving areas positioned on the mobile receiver, wherein the at least three effective visible light receiving areas are orientated such that a measurement of light intensity of a light from the same light source by each of the at least three effective visible light receiving areas is different from the others; and
producing an output which enables a 3-dimensional indoor positioning of the mobile receiver relative to a second coordinate system, based on (1) signals representing light intensities of lights from at least two different light sources positioned relative to the second coordinate system, measured by the at least three effective visible light receiving areas, (2) positions of the at least two different light sources relative to the second coordinate system and (3) the detected orientation of the mobile receiver relative to a first coordinate system.

2. The method of claim 1, wherein the 3-dimensional indoor positioning of the mobile receiver includes providing coordinates and an orientation of the mobile receiver relative to the second coordinate system.

3. The method of claim 1, wherein the method is performed by the mobile receiver, and the positions of the at least two different light sources relative to the second coordinate system is provided to the mobile receiver through one of an Internet connection, a pre-download, a communication with one of the at least two different light sources, and a communication with a different light source from the at least two different light sources.

4. The method of claim 1, wherein the processing includes:
calculating vectors between the mobile receiver and each of the at least two different light sources, based on the signals representing light intensities of the at least two different light sources; and
estimating the position of the mobile receiver relative to the second coordinate system.

5. The method of claim 4, wherein the step of estimating the position of the mobile receiver relative to the second coordinate system includes:
aligning the first coordinate system and the second coordinate system.

6. The method of claim 5, wherein the step of aligning the first coordinate system and the second coordinate system includes:
aligning the z-axis of the first coordinate system and the z-axis of the second coordinate system;
calculating a rotation angle required to align the x-axis and the y-axis of the first coordinate system, and the x-axis and y-axis of the second coordinate system; and
rotating the vectors based on the calculated rotation angle.

7. The method of claim 4, wherein the step of estimating the position of the mobile receiver relative to the second coordinate system includes:
processing the vectors so that the vectors are relative to the second coordinate system;
solving a minimization function of
$${arg min}_{( {s}_{x} , {s}_{y} , {s}_{z} )} {\sum }_{i = 1}^{k} {d}_{min}^{2} [ ( {s}_{x} , {s}_{y} , {s}_{z} ) , {γ}_{i} ]$$
where dₘᵢₙ[(sₓ, s_{y}, s_{z}), γᵢ] represents the minimum distance between ray γᵢ and (sₓ, s_{y}, s_{z}); [sₓ s_{y} s_{z}]^{T} is an estimate of of the position of the mobile receiver; γᵢ, i=1,2, . . . , k represent rays, parallel to the processed vectors, passing through the positions of the at least two different light sources.

8. The method of claim 4, wherein the processing further includes:
compensating an error of the 3-dimensional indoor positioning of the mobile receiver due to a physical distance between any two of the at least three effective visible light receiving areas.

9. The method of claim 8, wherein the step of compensating includes:
estimating the position and orientation of the at least two different light sources relative to the mobile receiver based on an assumption that the at least three effective visible light receiving areas are positioned at a geometric centre of the at least three effective visible light receiving areas;
calculating a power correction factor for each of the at least three effective visible light receiving areas based on the distance between each of the at least three effective visible light receiving areas and the geometric centre;
estimating the position of the mobile receiver relative to the second coordinate system based on the calculated power correction factor for each of the at least effective visible light receiving areas.

10. The method of claim 1, wherein the at least two different light sources are light sources producing lights of constant intensity.

11. The method of claim 1, wherein the at least two different light sources are LEDs.

12. The method of claim 1, wherein the at least two different light sources are programmed to transmit light signals of constant intensity in different time intervals.

13. The method of claim 1, wherein the at least two different light sources transmit information in relation to the second coordinate system to the mobile receiver.

14. An indoor positioning system, including:
at least two different light sources positioned relative to a second coordinate system for providing visible light signals to a single optical receiver; and
a mobile receiver, including:
a device for detecting an orientation of the mobile receiver relative to a first coordinate system;
at least three effective visible light receiving areas for measuring light intensities, wherein the at least three effective visible light receiving areas are orientated such that a measurement of light intensity of a light from the same light source by each of the at least three effective visible light receiving areas is different from the others; and
a processor programmed to produce an output which enables a 3-dimensional indoor positioning of the mobile receiver relative to a second coordinate system, based on (1) signals representing light intensities of lights from the at least two different light sources, measured by the at least three effective visible light receiving areas, (2) positions of the at least two different light sources relative to the second coordinate system, and (3) the detected orientation of the mobile receiver.

15. The indoor positioning system of claim 14, wherein the 3-dimensional indoor positioning of the mobile receiver includes providing coordinates and an orientation of the mobile receiver relative to the second coordinate system.

16. The indoor positioning system of claim 14, wherein the device for detecting an orientation of the mobile receiver relative to a first coordinate system is an accelerometer.

17. A mobile receiver, including:
a device for detecting an orientation of the mobile receiver relative to a first coordinate system;
at least three effective visible light receiving areas for measuring light intensities, wherein the at least three effective visible light receiving areas are orientated such that a measurement of light intensity of a light from the same light source by each of the at least three effective visible light receiving areas is different from the others; and
a processor programmed to produce an output which enables a 3-dimensional indoor positioning of the mobile receiver relative to a second coordinate system, based on (1) signals representing light intensities of lights from the at least two different light sources measured by the at least three effective visible light receiving areas, (2) positions of the at least two different light sources relative to the second coordinate system, and (3) the detected orientation of the mobile receiver.

18. The mobile receiver of claim 17, wherein the device for detecting an orientation of the mobile receiver relative to a first coordinate system is an accelerometer.

19. The mobile receiver of claim 17, wherein the 3-dimensional indoor positioning of the mobile receiver includes providing coordinates and an orientation of the mobile receiver relative to the second coordinate system.

20. A non-transitory computer readable medium including instructions to perform the method of claim 1.
